(19) United States
(12) Patent Application Publication
(10) Pub. No.: US 2022/0306776 A1
(43) Pub. Date: Sep. 29, 2022

(54) Nanocrystalline Materials Dispersed in Vinyl-Containing Polymers and Processes Therefor

(71) Applicant: Avery Dennison Corporation, Glendale, CA (US)

(72) Inventor: Kevin O. HENDERSON, Willoughby Hills, OH (US)

(21) Appl. No.: 17/633,221

(22) PCT Filed: Jul. 30, 2020
(86) PCT No.: PCT/US2020/044253

§ 371 Date: Feb. 7, 2022

Related U.S. Application Data
(60) Provisional application No. 62/883,179, filed on Aug. 6, 2019.
(60) Provisional application No. 62/937,826, filed on Nov. 20, 2019.

(51) Int. Cl. C08F 14/06; C08L 1/02; C08F 2/20; C08J 3/00; C08L 83/04; C08J 5/18

(52) U.S. Cl. CPC C08F 14/06; C08L 1/02; C08F 2/20; C08J 3/005; C08L 83/04; C08J 5/18; C08J 2327/06; C08J 2401/02; C08L 2205/035; C08J 2483/04

(57) ABSTRACT

Vinyl resin compositions containing nanocrystalline materials, films formed therefrom, laminates formed from such films, and methods of making and using thereof are described herein.

### CROSS-REFERENCE TO RELATED APPLICATIONS

The present application claims the benefit of U.S. Provisional Patent Application Nos. 62/883,179 filed Aug. 6, 2019 and 62/937,826 filed Nov. 20, 2019, the entire disclosures of which are incorporated herein by reference in their entireties.

### FIELD

The present subject matter relates to compositions containing one or more polymeric resins having dispersed or suspended therein one or more nanocrystalline materials, films made from such compositions, laminates made from such films, and methods of making and using thereof. The resulting compositions and films exhibit a variety of beneficial or improved characteristics including improved printability and weather stability.

### BACKGROUND

Poly(chloroethene) or polyvinyl chloride (PVC) is a widely produced synthetic plastic polymer. The two basic forms of PVC are flexible and rigid. Flexible PVC, hereafter referred to as vinyl film, is very useful in packaging and other decorations. The decorations can include, but are not limited to, pressure-sensitive labels, fleet graphics, car-wrapping films, and retro-reflective conspicuity articles.

To make PVC flexible, plasticizing agents must be added. In many applications, the vinyl can become unstable due to exposure to weather and UV radiation. Acid scavengers, heat stabilizers and/or UV stabilizers may be added to the PVC to mitigate these issues. All of these additives are not miscible with PVC, and gradually will migrate out of the vinyl film. Once these additives are depleted, the vinyl film begins to degrade. Weathering of the vinyl typically results in cracking, delamination, browning, shrinking or other undesirable physical changes in the product.

Many vinyl film products receive indicia, text, and/or graphic designs printed along an outer face of the product. Printing on the vinyl film is typically accompanied by inconsistent performance and/or appearance between printed areas or regions on the product. In addition, differences in print image quality, intensity, and/or resolution can also occur between printed regions on the product. Printability characteristics may be improved by the addition of additives to the vinyl film formulation. However, the addition of additives can increase the number of manufacturing steps and/or the cost of manufacturing. Thus, there exists a need for flexible vinyl films with improved printability characteristics.

Nanocrystalline cellulose may be added to PVC formulations for a variety of reasons, including 1) self-assembly to form a structured liquid crystal; (2) strength, due to high level of crystallinity; (3) thixotropy (shear thinning); (4) reactivity (surface have hydroxyl and acid groups that are reactive and can be functionalized to modify the properties); (5) photonics (forms solids with structural colors that lead to pearlescent and iridescent effects; and (6) electromagnetic properties (functional groups impact a negative charge to the surface which transmit electromagnetic properties to the crystal.

Flexible PVC film may be manufactured by casting or calendaring. When making a cast PVC film, which involves an organosol containing an organic liquid, the addition of nanocrystalline cellulose in the form of a water-based gel solution leads to compatibility problems (due to the very high surface energy and polar side branches of the nanocrystalline cellulose relative to the organic liquid in the organsol). Thus, the nanocrystalline cellulose cannot be properly mixed into the organosol from which the PVC film is cast and the nanocrystalline cellulose forms agglomerates and aggregates in the PVC film. This leads to problems, including the need to use higher levels of nanocrystalline cellulose to achieve the same performance properties. Likewise, when making a calendared PVC, which involves melting and mixing PVC powder, the addition of nanocrystalline cellulose in the form of a powder leads to problems as well.

Accordingly, there is a need to a process for forming a composite containing the PVC and nanocrystalline cellulose that alleviates these problems. The embodiments described herein are directed to these, as well other, important needs.

### SUMMARY

Vinyl resin compositions, films formed therefrom, laminates formed from such films, and methods of making and using thereof are described herein. In some embodiments, the compositions or films contain one or more nanomaterials. In some embodiments, the one or more nanomaterials contain, or is, nanocrystalline cellulose (NCC) or cellulose nanocrystals (CNC). Nanocrystalline cellulose (NCC) has a number of favorable attributes including: (1) self-assembly to form a structured liquid crystal; (2) strength, due to high level of crystallinity; (3) thixotropy (shear thinning); (4) reactivity (surface have hydroxyl and acid groups that are reactive and can be functionalized to modify the properties); (5) photonics (forms solids with structural colors that lead to pearlescent and iridescent effects; and (6) electromagnetic properties (functional groups impact a negative charge to the surface which transmit electromagnetic properties to the crystal).

NCC can improve the stability of additives, such as plasticizers, acid scavengers, UV stabilizers, heat stabilizers, print enhancing additives, and solvents/diluents. The addition of NCC can improve digital print performance of vinyl resins, such as PVC, without using an additive that can migrate out of the film. NCC-containing vinyl resin solutions have lower contact angles than resin solutions not containing NCC which indicates better “wet out” of inks or adhesives.

One embodiment is directed to compositions, comprising: at least one poly(chloroethene) resin; at least one nanocrystalline cellulose; at least one organic liquid suitable for suspending or dispersing said poly(chloroethene) resin; at least one polydimethylsiloxane; and optionally, at least one surfactant.

Another embodiment is directed to processes, comprising: providing a composition into a reactor, wherein the composition comprises: chloroethene monomer; nanocrystalline cellulose; and water; polymerizing the composition to form a composite, wherein the composite comprises: poly(chloroethene); and nanocrystalline cellulose; wherein the composite is the form of an aqueous dispersion.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic diagram of one embodiment for a process for forming poly(chloroethene).

FIG. 2 is a graph evaluating heat stability by measuring critical conductance time (seconds) as a function of concentration of nanocrystalline cellulose (NCC).

FIG. 3 shows solvent ink dot shapes with the addition of NCC.

FIG. 4 is a graph showing the thermal stability of PVC films having various loadings of NCC.

### DETAILED DESCRIPTION OF THE EMBODIMENTS

The present subject matter provides flexible vinyl films with improved properties including improved printability and weather stability. The vinyl films are formed from composition(s) that include one or more PVC resins, NCC, and at least one plasticizer. The composition may optionally contain at least one UV stabilizer, at least one heat stabilizer, and/or at least one print additive. In many embodiments, the vinyl compositions can be further improved by modifying the relationship between components in the formulation. In some applications, it may be beneficial to reduce the solubility between components; this is especially true of components that need to be at the surface. However, in other applications, optimizing the solubility may be desired.

The present subject matter also provides laminates utilizing the vinyl films and particularly those described herein. Generally, the laminates include a vinyl layer, a first adhesive layer proximate the vinyl layer. The laminates can additionally include a liner disposed on the first adhesive layer. However, the more complex retro-reflective laminates also include a spacing layer, a region of optical components, which can for example be in the form of glass beads dispersed between the first adhesive layer and the spacing layer, and a metalized layer. The vinyl layer or film is formed from the organosols described herein. These laminates can additionally include a layer of a second adhesive typically covering the metalized layer, and a liner disposed on the second adhesive layer. All of these laminates, variations thereof, and additional products are described herein.

The present subject matter further provides methods of producing the noted laminates and/or vinyl films. The vinyl films can be produced using a variety of techniques and particularly using an organosol casting process. These and other aspects of the present subject matter are described herein.

### I. Definitions

As employed above and throughout the disclosure, the following terms, unless otherwise indicated, shall be understood to have the following meanings.

As used herein, the terms “comprises,” “comprising,” “includes,” “including,” “has,” “having” or any other variation thereof, are intended are open-ended and cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” is employed to describe elements and components described herein. This is done merely for convenience and to give a general sense of the scope of the invention. This description should be read to include “one” or “at least one” and the singular also includes the plural, unless it is obvious that it is meant otherwise by the context. As used herein, the term “about,” when referring to a measurable value such as an amount and the like, is meant to encompass variations of ±10%, preferably, ±8%, more preferably, ±5%, even more preferably, ±1%, and yet even more preferably, ±0.1% from the specified value, as such variations are appropriate to perform the disclosed methods.

As used herein, “pressure sensitive adhesive” or “PSA” refers to a material that may be identified by the Dahlquist criterion, which defines a pressure sensitive adhesive as an adhesive having a one second creep compliance of greater than 1×10⁻⁶ cm²/dyne as described in Handbook of PSA Technology, Donatas Satas (Ed.), 2^{nd} Edition, page 172, Van Nostrand Reinhold, New York, N.Y., 1989. Since modulus is, to a first approximation, the inverse of creep compliance, pressure sensitive adhesives may also be defined as adhesives having a Young's modulus of less than 1×10⁶ dynes/cm². Another well-known means of identifying a pressure sensitive adhesive is an adhesive that it is aggressively and permanently tacky at room temperature and firmly adheres to a variety of dissimilar surfaces upon mere contact without the need of more than finger or hand pressure, and which may be removed from smooth surfaces without leaving a residue, as described in Glossary of Terms Used in the Pressure Sensitive Tape Industry provided by the Pressure Sensitive Tape Council, 1996. Another suitable definition of a suitable pressure sensitive adhesive is that it preferably has a room temperature storage modulus within the area defined by the following points as plotted on a graph of modulus versus frequency at 25° C.: a range of moduli from about 2×10⁵ to 4×10⁵ dynes/cm² at a frequency of about 0.1 radians/sec (0.017 Hz), and a range of moduli from about 2×10⁶ to 8×10⁶ dynes/cm² at a frequency of approximately 100 radians/sec (17 Hz). See, for example, Handbook of PSA Technology (Donatas Satas, Ed.), 2^{nd} Edition, page 173, Van Nostrand Rheinhold, N.Y., 1989. Any of these methods of identifying a pressure sensitive adhesive may be used to identify suitable pressure sensitive adhesives for use in the film constructions described herein.

All percentages noted herein are percentages by weight based upon the weight of the composition, unless indicated otherwise.

“Organosol,” as used herein, generally means a resin (e.g., vinyl-containing polymeric resin) suspended or dispersed in an organic fluid, especially organic liquid, such as diisobutyl ketone, for example, at a level of 5% by weight to 25% by weight, based on the total weight of the organosol formulation. The films described herein may be cast from organosols.

“PVC,” as used herein, refers to a vinyl-containing resin, more specifically, polyvinyl chloride, which is formed from the polymerization of chloroethene monomer. Alternatively, PVC or polyvinyl chloride is referred to herein as poly(chloroethene).

### II. Compositions and Films

A. Vinyl-Containing Resins

The compositions described herein, and the films made from the compositions, contain one or more vinyl-containing resins. Exemplary resins include, but are not limited to, polyvinyl chloride (PVC) or poly(chloroethene). In some embodiments, the one or more resin contains, or is, PVC. A wide array of PVC resins(s) can be used. Polyvinyl chloride is a thermoplastic polymer having the chemical formula (C₂H₃Cl)ₙ. In some embodiments, the molecular weight of the PVC resin(s) is in a range of from about 25,000 to about 250,000. However, it will be understood that the present subject matter includes the use of PVC resins having molecular weights outside of this range.

In some embodiments, the PVC is low molecular weight PVC, intermediate molecular weight PVC, high molecular weight PVC, or combinations thereof. These terms “low molecular weight,” “intermediate molecular weight,” and “high molecular weight” refer to PVC resins having K-values and/or molecular weights as follows.

TABLE 1
PVC Resins for Use in Vinyl Compositions and Vinyl Layers

| | | | Typical | Particular |
|---|---|---|---|---|
| | Typical | Particular | Molecular | Molecular |
| PVC Resin | K-Values | K-Value | Weights | Weights |
| Low | 48-72 | 68 | 34,700-101,900 | 87,600 |
| Molecular | | | | |
| Weight | | | | |
| Intermediate | 72-80 | 76 | 102,000-134,800 | 117,700 |
| Molecular | | | | |
| Weight | | | | |
| High | 80-92 | 83 | 134,900-195,500 | 148,700 |
| Molecular | | | | |
| Weight | | | | |

K-values, as known in the art, are an indication of average molecular weight of a polymeric sample or resin. K-values are a measure of molecular weight based on viscosity measurements, and are described in greater detail in “Encyclopedia of Polymer Science and Technology,” Vol. 14, John Wiley & Sons (1971); and “Molecular Weight and Solution Viscosity Characterization of PVC,” Skillicorn, D. E., Perkins, G. G. A., Slark, A., and Dawkins, J. V., Journal of Vinyl Technology, June 1993, Vol. 15, No. 2, Page 107.

The K-values noted in Table 1 above, are merely representative in nature and in no way limit the range or type of PVC resins, or combination of resins, that can be utilized in the PVC compositions and vinyl films or layers of the present subject matter.

If multiple resins are used, they are typically blended with one another to form a homogenous blended resin composition. The decision to blend PVC resins can be driven by a desire to optimize clarity, moisture permeation, dimensional stability or the tensile properties of the vinyl film. In some embodiments, the composition contains a blend of a low molecular weight PVC resin, an intermediate molecular weight PVC resin, and a high molecular weight PVC resin.

In some embodiments, a blend of a low molecular weight PVC resin, an intermediate molecular weight PVC resin, and a high molecular weight PVC resin is used to provide a relatively high initial reflectivity of a laminate as described herein, as compared to a corresponding laminate utilizing a vinyl layer with a single PVC resin. In addition, in many embodiments, vinyl layers utilizing a blend of a low molecular weight PVC resin, an intermediate molecular weight PVC resin, and a high molecular weight PVC resin exhibit desirable low modulus, and an acceptable low extent of shrinkage.

A variety of PVC resins can be used for the low, intermediate, and high molecular weight PVC resins. Many of these resins are commercially available. Nonlimiting examples of the high molecular weight PVC resin include Mexichem Vestolit G171, Formosa Formolon F-NVW, and SCG Chemicals PG770. Nonlimiting examples of the intermediate molecular weight PVC resin include Mexichem Vestolit G178, Formosa Formolon-1071, and SCG Chemicals PG740. Nonlimiting examples of the low molecular weight PVC resin include Mexichem Vestolit G173, Formosa Formolon-24A, and SCG Chemicals PG620. It will be understood that the present subject matter is not limited to any of these PVC resins and may include other PVC resins.

In certain embodiments, when utilizing a blend of low, intermediate, and high molecular weight PVC resins, it may be beneficial to utilize the combination of PVC resins in particular weight ratios to each other. In some embodiments, the ratio of concentrations of low molecular weight PVC, intermediate molecular weight PVC, and high molecular weight PVC is 15-60:15-60:40-90. It will be understood that the present subject matter is not limited to the use of PVC resins in the noted amounts or weight ratios, and instead includes other amounts, proportions, and/or weight ratios of PVC resin(s).

In some embodiments, the PVC resin(s) exhibit a relatively low plasticizer solubility which impedes migration of one or more components and particularly protective additives in the composition. In some embodiments, a high-molecular weight PVC is used to impede the migration of one or more components and particularly protective additives in the vinyl composition. The PVC resin(s) can also be less soluble in the plasticizer(s), thereby promoting the plasticizer to function on the surface of the PVC molecule. The PVC resin(s) can also be more compatible with the solvent(s) used in the composition. In some embodiments, the PVC resin(s) exhibit a high solvent solubility.

B. Nanocrystalline Materials

In some embodiments, the compositions described herein further contain one or more nanocrystalline materials. “Nanocrystalline material” as used herein refers to a polycrystalline material with a crystallite size typically from about 1 to about 100 nm. Nanocrystalline materials fill the gap between amorphous materials without any long range order and conventional coarse-grained materials. Definitions vary, but nanocrystalline materials are commonly defined as a crystallite (grain) size below 100 nm. Grain sizes from 100-500 nm are typically considered “ultrafine” grains.

Nanocrystalline materials can be prepared using a variety of methods. Methods are typically categorized based on the phase of matter the material transitions through before forming the nanocrystalline final product.

Solid-State Processing

Solid-state processes do not involve melting or evaporating the material and are typically done at relatively low temperatures. Examples of solid state processes include mechanical alloying using a high-energy ball mill and certain types of severe plastic deformation processes.

Liquid Processing

Nanocrystalline materials can be produced by rapid solidification from a liquid using a process such as melt spinning. This often produces an amorphous material, which can be transformed into a nanocrystalline material by annealing above the crystallization temperature. Liquid processing is typically used to prepare nanocrystalline metals.

Vapor-Phase Processing

Thin films of nanocrystalline materials can be produced using vapor deposition processes such as MOCVD.

Solution Processing

Some metals, particularly nickel and nickel alloys, can be made into nanocrystalline foils using electrodeposition.

In some embodiments, the nanocrystalline material contains, or is, nanocrystalline cellulose or nanocellulose. Nanocellulose is a term referring to nano-structured cellulose. This may be either cellulose nanocrystal (CNC or NCC), cellulose nanofibers (CNF) also called microfibrillated cellulose (MFC), or bacterial nanocellulose, which refers to nano-structured cellulose produced by bacteria. The NCC may contain or is native cellulose (i.e., unsubstituted cellulose). In other embodiments, the NCC may be functionalized to modify/improve the physical, chemical, and/or mechanical properties of the material. Functionalization may include covalent or non-covalent means to functionalize NCC. For example, the NCC can be functionalized to improve or enhance the printing properties and/or heat stability of PVC. In some embodiments, the functionalized or substituted NCC is not poly(cinnamoyloxy ethyl methacrylate) (PCEM).

CNF is a material composed of nanosized cellulose fibrils with a high aspect ratio (length to width ratio). Typical fibril widths are 5-20 nanometers with a wide range of lengths, typically several micrometers. It is pseudo-plastic and exhibits thixotropy, the property of certain gels or fluids that are thick (viscous) under normal conditions, but become less viscous when shaken or agitated. When the shearing forces are removed the gel regains much of its original state. The fibrils are isolated from any cellulose containing source including wood-based fibers (pulp fibers) through high-pressure, high temperature and high velocity impact homogenization, grinding or microfluidization (see manufacture below).

Nanocellulose can also be obtained from native fibers by an acid hydrolysis, giving rise to highly crystalline and rigid nanoparticles which are shorter (100 s to 1000 nanometers) than the nanofibrils obtained through homogenization, microfluiodization or grinding routes. The resulting material is known as cellulose nanocrystal (CNC).

The ultrastructure of nanocellulose derived from various sources has been extensively studied. Techniques such as transmission electron microscopy (TEM), scanning electron microscopy (SEM), atomic force microscopy (AFM), wide angle X-ray scattering (WAXS), small incidence angle X-ray diffraction and solid state ¹³C cross-polarization magic angle spinning (CP/MAS), nuclear magnetic resonance (NMR) and spectroscopy have been used to characterize typically dried nanocellulose morphology.

Pulp chemistry has a significant influence on nanocellulose microstructure. Carboxymethylation increases the numbers of charged groups on the fibril surfaces, making the fibrils easier to liberate and results in smaller and more uniform fibril widths (5-15 nm) compared to enzymatically pre-treated nanocellulose, where the fibril widths were 10-30 nm. The degree of crystallinity and crystal structure of nanocellulose. Nanocellulose exhibits cellulose crystal I organization and the degree of crystallinity is unchanged by the preparation of the nanocellulose. Typical values for the degree of crystallinity were around 63%.

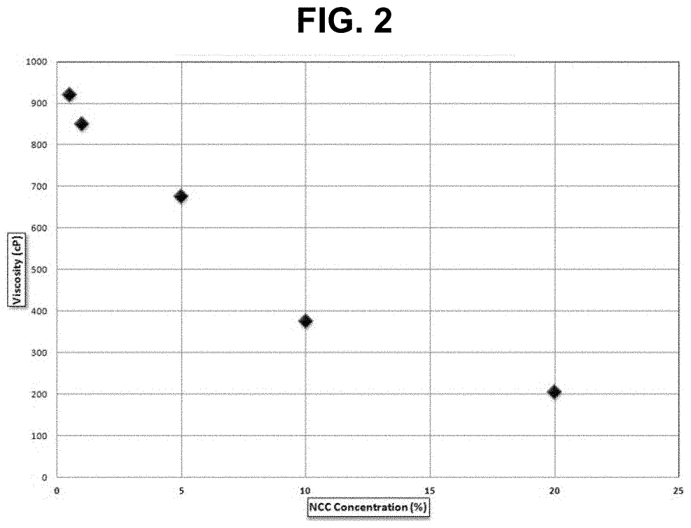

The concentration of NCC can vary based on the desired properties of the films or laminates containing the films, such as, for example, method in which the NCC is incorporated into the organosol. In some embodiments, the concentration of NCC in the organosol used to cast films is from about 0.01% to about 5%, from about to 0.01% to about 3%, from about to 0.01% to about 1%, from about to 0.1% to about 1%, or from about to 0.1% to about 0.5% by weight of the organosol. In some embodiments, the concentration of the NCC in the organosol is less than about 3.5%, 3.0%, 2.5%, 2.0%, 1.5%, 1.0%, 0.5%, 0.25%, or 0.1% by weight of the organosol. NCC added in-situ in the PVC resin process can be used at a lower concentration than NCC admixed directly into a vinyl organosol. The addition of NCC to a vinyl organosol lowers the viscosity (FIG. 2), which may negatively affect the ability to cast the vinyl at higher concentrations.

C. Plasticizer(s)

In some embodiments, the compositions described herein further contain one or more plasticizers. A wide array of plasticizer(s) can be used in the vinyl compositions and vinyl films of the present subject matter. In some embodiments, the plasticizer(s) exhibits heat stabilizing properties. In some embodiments, the plasticizer(s) exhibits low solubility with other additives and/or components of the vinyl composition.

In some embodiments, the plasticizer(s) selected is bio-based. The term “bio-based” as used herein refers to a plasticizer that includes or is formed from biological products or renewable agricultural materials including plant, animal, and/or marine materials. An example of a bio-based plasticizer is a plasticizer prepared from soybeans, corn, and/or other agricultural products for example. Another example of a bio-based plasticizer is a plasticizer made from natural oils and fats. Typically, bio-based plasticizers exhibit better biodegradability as compared to non-bio-based plasticizers due to the presence of epoxides. In particular embodiments the bio-based plasticizer(s) has an inherent heat stabilizing property, but has less solubility with other additives and/or components of the composition. Although a monomeric plasticizer can be used in certain embodiments, due to its low molecular weight, monomeric plasticizers are typically not used for long-term weathering applications. Thus, more complex polymeric plasticizers with higher molecular weights are used in the vinyl compositions in accordance with the present subject matter.

Non-limiting examples of commercially available bio-based plasticizer(s) which can be used in the vinyl compositions include, but are not limited to, Drapex® Alpha 200, Drapex® Alpha 200C, Drapex® Alpha 210, and Drapex® Alpha 220 available from Galata; Edenol® D 81, Edenol® D 82 S, Edenol® B 316 Spezial, Edenol® 1234, Edenol® 9789, Edenol® 1208, and Edenol® 1233 Spezial available from Emery Oleochemicals; Polysorb® ID available from Roquette; Oxblue® DOSX and Oxblue® ABTC available from Oxea; DOSX available from Myriant; and Proviplast® 1044, Proviplast® 2644, Proviplast® 01422, Proviplast® PLS Green 5, and Proviplast® PLS Green 8 available from Proviron. It will be understood that the present subject matter is not limited to any of these plasticizers, and may use other plasticizers.

In some embodiments, the plasticizer(s) used in the vinyl compositions exhibit a relatively high degree of incompatibility and/or are insoluble with respect to water. In some embodiments, such plasticizers are derived from adipic acid and polyhydric alcohols. A nonlimiting example of such plasticizer is Palamoll® 656 (CAS No. 208945-12-4), commercially available from BASF.

D. Acid Scavengers

In some embodiments, the compositions described therein, or films made therefrom, contain one or more acid scavengers. A variety of acid scavengers can be used in the vinyl compositions and vinyl films described herein. It is presumed that the eventual degradation of the vinyl film is inevitable. Once HCl starts to form, the rate of vinyl degradation is exponential. Acid scavengers are used to counteract the initial formation of HCl and thus prolong the life of the vinyl film article.

Epoxides are the most common type of acid scavenger used in vinyl films. In some embodiments, the use of one or more epoxide(s) in the vinyl compositions can promote various properties and characteristics of vinyl films and laminates using the vinyl films. In certain applications, epoxides provide the dual functionality of acting as a plasticizer and an acid scavenger. This improves the flexibility of the vinyl film and enhances the heat stability by delaying the onset of degradation from thermal sources.

However, incorporation of epoxides in the vinyl composition can result in reduction of reflectivity and/or other undesirable optical properties of the vinyl films and laminates. Epoxides can migrate into and plasticize the spacing layer. Once the spacing layer is plasticized, it may be more easily deformed by high heat. Once the spacing layer is deformed, the metal layer may no longer function to create a retro-reflective product.

In view of the potential limitations of epoxides for use as acid scavengers for films used in reflective applications, other materials may be used as acid scavengers. In some embodiments, the acid scavenger is a solid particle, such as hydrotalcites. For retro-reflective materials, such solid materials may not be ideal since it is desirable to avoid anything between the metal layer and the outer surface of the vinyl layer that may refract or diffuse light. For such applications, compatible liquids with a low refractive index, such as 1-methylimidazole, may be used. The potential for a large particle to refract light makes NCC a preferred cellulose option over CNF.

E. UV Stabilizers

In some embodiments, one or more UV stabilizer(s) can be used in the vinyl compositions and vinyl films described herein. A variety of UV stabilizers can be used. The most common types of UV stabilizers are cyanoacrylates, benzophenones, benzotriazoles, triazines and oxanilides. Certain UV stabilizers may be migratory which can detrimentally affect physical properties of resulting vinyl films and laminates. Others UV stabilizers have unexpected plasticizing properties which are lost if the UV stabilizer is not stable in the vinyl film. Therefore, in some embodiments, the one or more particular UV stabilizers do not adversely affect the physical properties of the compositions or films described herein, and in some embodiments, may lead to improved properties.

In some embodiments, the UV stabilizer(s) are oxanilide or oxanilide-based compounds. UV stabilizers of this type is available commercially from various sources under the Clariant tradename Hostavin 3206 liq and the BASF tradename Tinuvin 312.

Other UV stabilizers include oligomeric hindered amine light stabilizer (HALS) which are commercially available under the Clariant tradename Hostavin 3070P. Additional examples of hindered amine light stabilizers which are commercially available and which can be used in the vinyl compositions include Clariant's Hostavin TB-03, Hostavin TB-04 and AddWorks LXR 308; BASF's Tinuvin 123 and 292; and 3V's Uvasorb HA10 and HA88FD. The HALS can be used as enhancers to a primary UV stabilizer. The UV stabilizer to HALS ratio can range from 9:1 to 6:4. Combinations of any of these UV stabilizers and HALS can be used.

F. Heat Stabilizers

In some embodiments, one or more heat stabilizer(s) can be used in the vinyl compositions and vinyl films described herein. In some embodiments, the heat stabilizers include calcium (Ca) and zinc (Zn); in other embodiments, barium (Ba) and zinc (Zn) systems are preferred. In some embodiments, an increased Ba/Zn ratio has been found to reduce one or more detrimental effects that may arise when utilizing other heat stabilizers. In those embodiments, the barium-zinc heat stabilizer has a molar ratio of Ba/Zn which is greater than 3.85:1, and in certain versions greater than 4:1, respectively. In certain applications, suitable heat stabilizer(s) may include phosphorus (P).

For barium-zinc heat stabilizers, it was found that selecting a heat stabilizer with a higher barium content improves solvent ink dot diameter. And selecting a heat stabilizer with a lower zinc content tends to reduce the solvent ink dot diameter, and have a greater impact than a higher barium content. Thus, for a heat stabilizer containing two metals and particularly for barium-zinc heat stabilizers, the noted ratios of barium to zinc described herein have been discovered to surprisingly produce vinyl films and laminates with excellent characteristics.

In some embodiments, a heat stabilizer that is relatively incompatible, e.g., insoluble, with the plasticizer(s) used in the vinyl compositions leads to improved performance of the resulting vinyl films and/or laminates.

Examples of commercially available heat stabilizers that have been found to promote improved performance of the vinyl films and laminates include Mark 4887 and Mark 4825 available from Galata Chemicals. Mark 4887 and Mark 4825 are both barium-zinc heat stabilizers. A variety of other and potentially useful heat stabilizers are available from other suppliers including for example Valtris Specialty Chemicals, Adeka, Baerlocher, Reagens, Kolon Industries, and Halstab. However, it will be appreciated that the present subject matter is not limited to any of these heat stabilizers, and may instead utilize one or more other heat stabilizer(s).

G. Print Enhancing Additive(s)

In some embodiments, one or more print enhancing additive(s), in addition to NNC, can be used in the vinyl compositions and vinyl films described herein. Nonlimiting examples of print enhancing additive(s) include surfactant(s), polydimethyl siloxane(s), and/or other agent(s). Combinations of one or more of these agents can be used.

The vinyl compositions may also contain one or more surfactants. Surfactant(s) may be utilized in the vinyl compositions to improve properties of the resulting vinyl films. The one or more surfactants are selected from non-ionic surfactants, anionic surfactants, cationic surfactants, or combinations thereof. Nonlimiting examples of potentially suitable surfactants include BYK-3560, DISPERBYK, DISPERBYK-2200, and BYK-4512 available from BYK Additives and Instruments; Dispex® Ultra PA 4512 available from BASF; and Disparlon® LF-1985, Disparlon® LPH-810, Disparlon® SPL-85, Disparlon® UVX-35, and Disparlon® UVX-36 available from Kusumoto Chemicals. For example, polyacrylate-based surfactants can improve dot circularity as compared to a vinyl composition free of such agents.

The vinyl compositions may contain one or more polydimethyl siloxane(s), which are typically known in the art as PDMS. Although a wide array of PDMS agents can be used in the vinyl compositions, in many embodiments it may be preferred that the PDMS exhibits a viscosity greater than 40 cSt. Nonlimiting examples of potentially suitable PDMS agents include DMS-515, DMS-521, and DMS-S27 available from Gelest; Xiameter OFX-5211 and Xiameter PMX-0156 available from Dow Corning; PSF-50cSt, and PSF-100cSt available from ClearCo; and PDMS agents available from Sigma Aldrich. In certain applications, it has been found that the use of certain print enhancing additives leads to improved circularity of print dots. Polydimethyl siloxane in a vinyl composition can also improve the uniformity of print dots. Use of both of these agents in combination can produce print dots having improved dot shape and size as compared to the use of vinyl compositions containing only one of these agents.

In some embodiments, the heat stabilizer, UV stabilizer, and acid scavenger are selected so that they exhibit improved compatibility, and in certain embodiments, optimal compatibility with each other, and the solvent. In some embodiments, the Ba/Zn ratio of the heat stabilizer can be increased to reduce the negative impact on printing. In some embodiments, a hindered-amine light stabilizer (HALS) is utilized and added to the UV stabilizing package. The HALS is typically a solid that is less soluble in the solvent, which will ensure that some UV protection remains in the vinyl. However, for retro-reflective products, a liquid HALS is preferred when available. A higher molecular weight acid scavenger can also be used.

In some embodiments, NCC and PDMS in combination are used to improve printability. Compositions having a NCC/PDMS weight ratio of 1.2:1 produced the optimal dot diameter for digital solvent printing. In some embodiments, the overall concentration of NCC and PDMS does not exceed 1.00% by weight in the final vinyl film.

The resultant vinyl composition may be more weatherable, delaying the generation of product-killing acid. The tailored solubility of the additives, combined with the higher molecular weight of the PVC, can reduce migration of key additives to the surface that would be deleterious to printing and adhesive performance, including, for example, adhesion to a urethane bonding layer used in many laminate products. The resulting product is clear and glossy, as desired, and the resulting product exhibits improved solvent digital printability.

The vinyl compositions may contain one or more light stabilizer(s), and particularly one or more hindered amine light stabilizer(s) or HALS as described above. These are typically in addition to the UV stabilizers described above. In many versions these agents are in solid form at ambient conditions. Moreover, in many embodiments the HALS exhibit low solvent solubility to impede migration of components or additives in the vinyl composition.

H. Solvent(s) and/or Diluent(s)

The vinyl compositions can include one or more solvent(s). A wide array of solvents can be used, many of which are commercially available such as HiSol 10 and Aromatic 100, both of which are blends of various petroleum distillates. Incorporation of solvent(s) in the vinyl composition promotes blending and mixing of components, application of the composition, and/or formation of a vinyl layer or film. The solvent(s) are typically removed from the composition during drying, curing, and/or layer formation.

### III. Multilayer Constructions

The NCC-containing films described herein can be used for a variety of applications including, but not limited to, graphics application, such as automobile and architectural wraps; reflective applications, such as road and traffic signs, trains and other commercial vehicles, etc.; and label applications. Such films are typically incorporated into multilayer structures, or laminates, containing other components suitable for a particular application. Exemplary components include, but are not limited to, spacing layers, tie layers, adhesive layers, optical component-containing layers, metallic layers, barrier layers, release liners, and combinations thereof.

The thickness of the vinyl film can be varied. However, if the film is too thin, the resulting reduction in modulus and tensile strength may render the film susceptible to breaking or tearing when removing, processing, or using. If the tensile strength is too low, the matrix may also break easily when performing post film processing operations such as “weeding” sign cut letters. The noted maximum thickness of the vinyl film achieves a good balance between conformability and strength of the film. Thicknesses greater than that noted herein may exhibit unacceptable conformability characteristics. In some embodiments, the thickness of vinyl film containing the nanocrystalline material (e.g., nanocrystalline cellulose) is less than about 3 mils (75 microns), 2.5 miles, 2.0 mils, 1.5 mils, 1.0 mil, or 0.5 mils.

A. Spacing Layer

The laminates for retro-reflective applications described herein may contain a spacing layer disposed between the optical layer/region and the metal layer. The spacing layer serves to retain and affix the optical layer and/or optical components of that layer or region. The spacing layer also serves to appropriately space the optical component(s) from the metal layer and/or space the optical component(s) from the outer surface of the laminate. The resins that may be used for the spacing layer include a variety of partially amorphous or semi-crystalline thermoplastic polymers which are transparent or substantially so, and generally have a soft stage during which the optical components can be embedded in the spacing layer.

In some embodiments, the adhesion between the spacing layer and adjacent layers or materials is greater than the tensile strength of the materials. Acrylics, polyvinyl butyrals (PVBs), aliphatic urethanes and polyesters are particularly useful polymeric materials for the spacing layer because of their stability to outdoor environmental conditions. Copolymers of ethylene and an acrylic acid or methacrylic acid, vinyls, fluoropolymers, polyethylenes, cellulose acetate butyrate, polycarbonates and polyacrylates are other examples of polymers or polymeric materials that can be used for the spacing layers in the laminates of the present subject matter. Combinations of these components can also be used.

In some embodiments, the material used in the spacing layer is polyvinyl butyrate (PVB). In some embodiments, the PVB is a commercially available PVB, such as Butvar B-90 from Solutia or B-08SY from TRiiSO.

B. Optical Component(s)

The laminates for retro-reflective applications described herein may also contain at least one layer or region of optical component(s). The layer(s) or region(s) constituting the optical components are typically embedded within or along a portion, and typically along a face, of the spacing layer. The optical components are typically transparent or substantially so, and in the form of microspheres having certain refractive indexes.

The optical components utilized in the laminates, if in a particulate form, may have an average diameter in a range of from about 25 to about 300 microns, 30 to about 120 microns, or from about 40 to about 80 microns. The index of refraction of the optical components is generally in a range from about 1.9 to about 2.5, from about 2.0 to about 2.3, or from about 2.10 to about 2.25.

Glass microspheres can be used for the optical components, although ceramic microspheres such as those made by sol/gel techniques can also be used. The index of refraction and the average diameter of the microspheres, and the index of refraction of other layers and the spacing layer dictate the thickness of the spacing layer. The microspheres can be subjected to chemical or physical treatments to improve the bond of the microspheres to the layers and or regions of the laminates. For example, the microspheres can be treated with a fluorocarbon or an adhesion promoting agent such as an aminosilane to improve the bond, or the spacing layer in which the microspheres have been embedded can be subjected to a flame treatment or corona discharge to improve the bond between the spacing layer and microspheres to any adjacent layers.

In some embodiments, the laminates can include one or more prismatic structures instead of, or in combination with, the glass microspheres or other particulate optical components described herein. Thus, it will be understood that the present subject matter includes a wide array of optical components that can be used in the laminates and/or reflective products.

C. Metal Layer

In some embodiments, the laminates may also contain at least one metal layer. In some embodiments, the metal layer includes a reflective metal such as silver or aluminum.

The metal can be applied or disposed using a variety of methods. In some embodiments, the metal is applied by evaporative methods (thermal or electron beam) or by cathodic sputtering (magnetron or reactive) over the second surface of the spacing layer. The thickness of the reflective layer depends on the particular metal used and is generally between about 500 and 1,000 nanometers. However, it will be understood that the present subject matter includes a wide array of variations for this layer.

D. Adhesives

In some embodiments, the laminates may include one or more layers or regions of adhesive. In some embodiments, the first layer of adhesive includes one or more structural adhesives. Examples of such a material include, but are not limited to, urethane adhesives. However, pressure sensitive adhesives with suitable bond strength and refractive index may also be suitable as a first layer adhesive. As noted, in many versions the adhesives used in the second layer of adhesive include pressure sensitive adhesive(s).

The first adhesive layer used in the laminates is typically disposed between a vinyl film or layer, and the spacing layer. As noted, in some embodiments, the first adhesive layer includes one or more urethane adhesives. In many formulations, the urethane adhesive is prepared by combining a polyol component and an isocyanate component with optional crosslinker(s). Crosslinking and/or chemical bonding with certain functional groups in the adjacent vinyl layer, such as —OH groups, particularly those in the plasticizer(s) in the vinyl layer, can lead to improved adhesion and physical affixment between the vinyl layer and the first adhesive layer.

Nearly any pressure sensitive adhesive (PSA) composition known in the art can be used in the laminates. Such adhesive compositions are described in, for example, “Adhesion and Bonding,” Encyclopedia of Polymer Science and Engineering, Vol. 1, pp. 476-546, Interscience Publishers, Second Ed., 1985. Such compositions generally contain an adhesive polymer such as natural or reclaimed rubbers, styrene-butadiene rubber, styrene-butadiene or styrene-isoprene block copolymers, polyisobutylene, poly(vinylether) or poly(acrylic)ester as a major constituent. Other materials may be included in the pressure sensitive adhesive composition such as resin tackifiers including rosin esters, oil-soluble phenolics and polyterpenes; antioxidants; plasticizers such as mineral oil or liquid polyisobutylene. Fillers are not used in the first layer adhesive in highly reflective articles, as this can scatter light and reduce the retro-reflectivity of the article. Fillers can be used in applications that are limited to a maximum reflectivity. The selection of the pressure sensitive adhesive to be used in any laminates of the subject matter is not critical, and those skilled in the art are familiar with many suitable pressure sensitive adhesives for particular applications.

Either or both of the first and/or second adhesive layers may be patterned. Either or both of these layers can optionally include one or more non-continuous regions of adhesive and/or include regions that are free of adhesive.

It will be appreciated that each of the above described adhesives may be provided as solvent based, emulsions, hot melt adhesives, UV curable, or radiation curable. Additionally, each of the adhesives may be made removable or permanent. The system and performance characteristic of the adhesives may be selected as desired for a particular purpose or intended use.

E. Release Liners

In some embodiments, the vinyl-based laminates include one or more release liners. The liners typically cover or overlie otherwise exposed faces or regions of the second adhesive, which is typically a PSA.

Release coated liners may contain a release coated laminate containing more than one sheet material including alternating layers of paper and polymer to provide desirable properties. The following examples of laminates illustrate these types of laminates which may be utilized as the release-coated liners in the laminates of the present subject matter: release composition/polyethylene/paper; release composition/paper/polyethylene; release composition/polyvinylchloride/paper; release composition/polyethylene/paper/polyethylene/tissue; etc. In these examples of release coated liners, the polyethylene films may range from low density to high density, and the paper materials may be any paper materials.

In some embodiments, a variety of layer arrangements can be used so long as at least a portion of the spacing layer is disposed between the optical components and the metal layer. In other embodiments, the laminate features the first adhesive layer disposed between the vinyl film and at least one of (i) the optical components and (ii) the spacing layer. In another embodiment, the metal layer is disposed between the spacing layer and the second adhesive layer. In another embodiment, the vinyl film is disposed immediately adjacent to the first adhesive layer. In another embodiment, the optical components are disposed between the first adhesive layer and the metal layer. The present subject matter is not limited to any of these particular versions and includes laminates exhibiting combinations of these features and embodiments.

F. Print Layers

In some embodiments, the laminates include one or more layers and/or regions of print. The print or printing composition can be applied or otherwise deposited on the vinyl film or layer, or other layers of the laminate. It is also contemplated that one or more auxiliary layers such as top coats and over-laminate films can be applied to the vinyl layer and print then disposed on the top coat(s) or overlaminate films. The present subject matter also includes applying top coat(s), protective layer(s), or overlaminate films on the print surface of a laminate.

A wide array of print compositions can be used in association with the present subject matter. Many such compositions are known in the art and/or are commercially available. Non-limiting examples of such print compositions include inks, coatings, paintings, and toner. The print compositions can be applied by known techniques. In many versions of the present subject matter, print composition(s) are applied directly to an outer face of the vinyl layer of a laminate. As described herein, as a result of characteristics of the vinyl layer, improved properties of the resulting printed layer, region, text, and/or design are attained. Moreover, the addition of NCC to vinyl resin containing compositions (e.g., organosol, from which films are cast) showed improved eco-solvent print dot formation.

The laminate structure may have a thickness as desired to provide a laminate having suitable characteristics and properties as desired for a particular purpose or intended use. In one embodiment, the laminate structure has an overall thickness of from about 1.5 mils to about 15 mils (about 35 microns to about 350 microns). In another embodiment, the laminate structure has an overall thickness of from about 3 mils to about 10 mils (about 70 microns to about 254 microns). In still another embodiment, the laminate structure has an overall thickness of from about 5 mils to about 8 mils (about 120 microns to about 205 microns).

### IV. Process for Manufacture

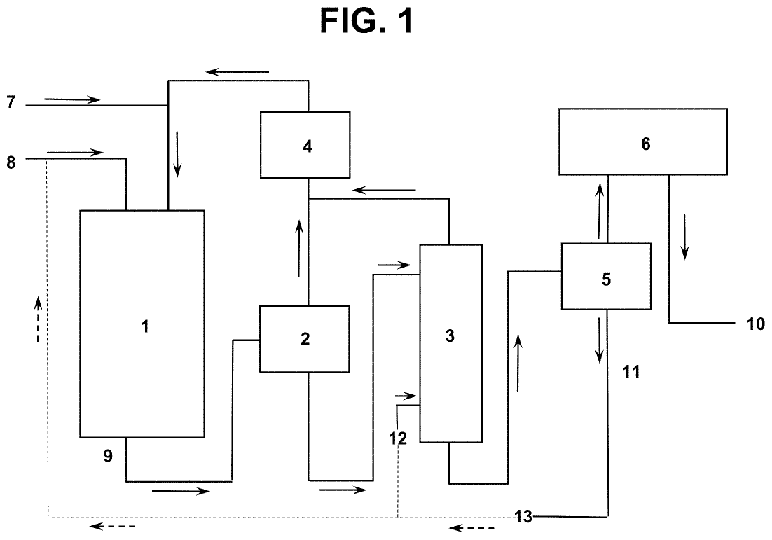

FIG. 1 is a schematic diagram of one embodiment for a process for forming poly(chloroethene). Into a batch reactor 1, chloroethene monomer 7 and a mixture of water, nanocrystalline cellulose and optional additives 8 are mixed and reacted to form poly(chloroethene) with nanocrystalline cellulose (wet product with residual monomer) 9. The wet product 9 is vented to remove residual monomer vapor in the venting unit 2. The residual monomer vapor then moves to the monomer recovery unit 4, and then recycled back to the batch reactor 1. The wet product then moves to the steam stripping unit 3, which removes additional residual monomer vapor and sends it to the monomer recovery unit 4, which is also recycled back to the batch reactor 1. The wet product then moves to the water removal unit 5, where water is removed and recycled back to the batch reactor 1 and the remaining wet product moves to the drying unit 6 to remove additional water leaving the final dry poly(chloroethene) with nanocrystalline cellulose.
1 batch reactor
2 monomer vapor venting unit
3 steam stripping unit
4 monomer recovery unit
5 water removal unit
6 drying unit
7 chloroethene monomer
8 water, nanocrystalline cellulose, and optional additives
9 poly(chloroethene) with nanocrystalline cellulose (wet)
10 poly(chloroethene) with nanocrystalline cellulose (dry)
11 removed water
12 steam
13 re-use of water

In certain embodiments, the poly(chloroethene) is particulate in nature. In certain embodiments, the nanocrystalline cellulose is deposited on a surface of the poly(chloroethene) particles.

In certain embodiments, the process further comprises the step of drying the aqueous dispersion to form a dried composite.

In certain embodiments, the nanocrystalline cellulose is present in the composite at a level of less than 3.5% by weight, based on the total weight of the composite, preferably, at a level of less than 1% by weight, based on the total weight of the composite, more preferably, at a level of less than 0.5% by weight, based on the total weight of the composite.

In certain embodiments, the process further comprises the step of preparing an organsol, wherein said organosol comprises: the composite; and an organic fluid for suspending or dispersing the composite; and casting a film from the organosol.

In certain embodiments, the process further comprises the steps of: drying the aqueous dispersion to form a dried composite; melting the dried composite to form a melted composite; and calendering a film from the melted composite.

The present invention is further defined in the following Examples, in which all parts and percentages are by weight, unless otherwise stated. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various usages and conditions.

### EXAMPLES

### Example 1: Improved Digital Solvent Printing

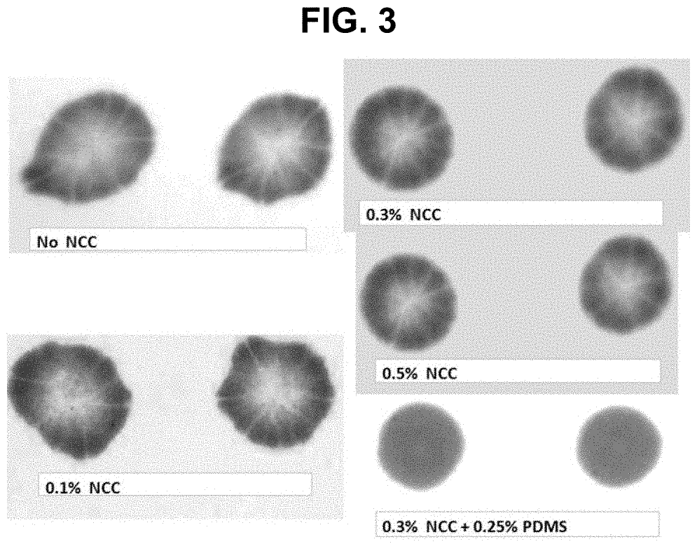

The addition of NCC to vinyl organosols showed improved ecosolvent print dot formation (FIG. 3). The ink dots became more circular and more uniform with increasing NCC levels. The addition of PDMS codified the uniformity at a lower CNC usage.

### Example 2: Improved Heat Stability

The heat stability was determined by using Metrohm's Metrastat dehydrochlorination test method. This is a device designed to measure the thermal stability of PVC and other chlorine-containing polymers. It is based on heating the sample to induce decomposition that results in the release of gaseous HCl. A continuous stream of nitrogen that passes through the sample transports this HCl from the sample vessel into a vessel containing distilled water. The conductivity of that water is continuously measured. Conductivity increases in this vessel once HCl emerges. The time at which a 50 μS/cm increase is reached compared to the beginning of the measurement is called the stability time.

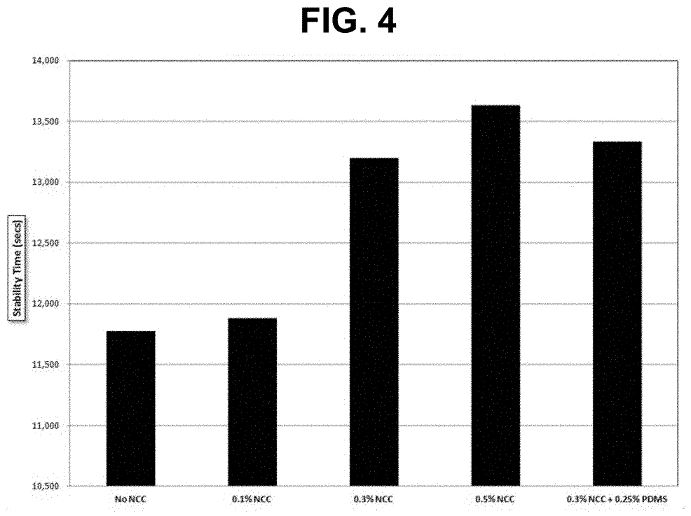

The addition of NCC also resulted in a noticeable improvement in heat stability when added to a vinyl organosol. The concentration of NCC as a function of critical conductance time (sec) was evaluated. The results are shown in FIG. 4. The vinyl organosol without NCC showed a critical conductance time of 8,000 secs. In contracts, the addition of NCC at concentrations of 0.1%, 0.3%, and 0.5% resulted in critical conductance times of 9,000, 10,000, and 10,500 secs, respectively.

When ranges are used herein for physical properties, such as molecular weight, or chemical properties, such as chemical formulae, all combinations, and subcombinations of ranges specific embodiments therein are intended to be included.

The disclosures of each patent, patent application, and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

1. A process, comprising:
providing a composition into a reactor, wherein the composition comprises:
chloroethene monomer;
nanocrystalline cellulose; and
water;
polymerizing the composition to form a composite, wherein the composite comprises:
poly(chloroethene); and
nanocrystalline cellulose;
wherein the composite is the form of an aqueous dispersion.

2. The process of claim 1,
wherein the poly(chloroethene) is poly(chloroethene) particles; and wherein the nanocrystalline cellulose is deposited on a surface of the poly(chloroethene) particles.

3. The process of claim 1, further comprising:
drying the aqueous dispersion to form a dried composite.

4. The process of claim 1,
wherein the nanocrystalline cellulose is present in the composite at a level of less than 3.5% by weight, based on the total weight of the composite.

5. The process of claim 1,
wherein the nanocrystalline cellulose is present in the composite at a level of less than 1% by weight, based on the total weight of the composite.

6. The process of claim 1,
wherein the nanocrystalline cellulose is present in the composite at a level of less than 0.5% by weight, based on the total weight of the composite.

7. The process of claim 1, further comprising:
preparing an organsol, wherein said organosol comprises:
the composite; and
an organic fluid for suspending or dispersing the composite; and
casting a film from the organosol.

8. The process of claim 1, further comprising:
drying the aqueous dispersion to form a dried composite;
melting the dried composite to form a melted composite; and
calendering a film from the melted composite.

9. A product produced by the process of claim 1.

10. A composition comprising:
at least one poly(chloroethene) resin;
at least one nanocrystalline cellulose;
at least one organic liquid suitable for suspending or dispersing said poly(chloroethene) resin;
at least one polydimethylsiloxane; and
optionally, at least one surfactant.

11. The composition of claim 10,
wherein the at least poly(chloroethene) resin is a mixture comprising:
at least one low molecular weight poly(chloroethene) resin;
at intermediate molecular weight poly(chloroethene) resin; and
at high molecular weight poly(chloroethene) resin.

12. The composition of claim 11,
wherein the poly(chloroethene) resin comprises:
5-60 parts per hundred of the low molecular weight poly(chloroethene) resin;
5-60 parts per hundred of the intermediate molecular weight poly(chloroethene) resin; and
35-90 parts per hundred of the high molecular weight poly(chloroethene) resin.

13. The composition of claim 10,
wherein the nanocrystalline cellulose is present at a level of 0.1% by weight to 3.5% by weight, based on the total weight of the composition.

14. The composition of claim 10,
wherein the ratio of the at least one nanocrystalline cellulose to at least one polydimethylsiloxane does not exceed 1.5:1.

15. A film comprising the composition of claim 10.
